(19) United States
(12) Patent Application Publication
(10) Pub. No.: US 2023/0357536 A1
(43) Pub. Date: Nov. 9, 2023

(54) Process For Crosslinking Polysaccharides From Macroalgae to Form a Polymer Material

(71) Applicant: Brabender GmbH & Co. KG, Duisburg (DE)

(72) Inventors: Ludwig Schmidtchen, Dresden (DE); Martin Schwarz, Oberhausen (DE); Michael Landers, Oberhausen (DE)

(73) Assignee: Brabender GmbH & Co. KG, Duisburg (DE)

(21) Appl. No.: 18/144,231

(22) Filed: May 7, 2023

(30) Foreign Application Priority Data
May 9, 2022 (EP) EP 22172276.2

(51) Int. Cl. C08K 5/053

(52) U.S. Cl. CPC C08K 5/053

(57) ABSTRACT

The present invention relates to a process for crosslinking polysaccharides from macroalgae to yield a polymer material in a processing chamber. The process includes the steps of producing a mixture comprising a solid containing polysaccharide from macroalgae and a water-containing liquid, with a ratio of liquid to solid of between 3:1 and 1:9, adjusting a pressure acting on the mixture to at least the vapour pressure of water at a first temperature, the first temperature being greater than/equal to 100° Celsius, and heating the mixture to the first temperature, wherein the solid comprises as polysaccharide at least one of alginate, alginic acid, agar and/or Carrageenan. The invention further relates to a process for producing a biopolymer product from such a polymer material in an apparatus comprising a processing chamber and a shaping apparatus. The invention also relates to a biopolymer product obtained by such a process.

### CROSS REFERENCE TO RELATED PATENT APPLICATIONS

This application claims priority to European Patent Application EP 22172276.2 filed on May 9, 2022 entitled “Verfahren zum Vemetzen von Polysacchariden aus Makroalgen zu einem Polymerwerkstoff” (Process For Crosslinking Polysaccharides From Macroalgae to Form a Polymer Material) by Ludwig Schmidtchen, Martin Schwarz and Michael Landers, the entire disclosure of which is incorporated herein by reference in its entirety.

### FIELD OF THE INVENTION

The present invention relates to a process for crosslinking polysaccharides from macroalgae to form a polymer material in a processing chamber. The invention further relates to a process for producing a biopolymer product from such a polymer material in an apparatus comprising a processing chamber and a shaping apparatus. The invention also relates to a biopolymer product obtained by such a process.

### BACKGROUND OF THE INVENTION

Processes for crosslinking polysaccharides from macroalgae and for producing biopolymer products therefrom exist today. Typically in these processes a solution composed of solid comprising polysaccharide from macroalgae and a water-containing liquid, with a ratio of liquid to solid in the 7:1 to 20:1 range, is produced and poured into a mould. After crosslinking of the polysaccharides in the solution, and drying of the liquid, a polymer product then remains. Disadvantages of such an operation include a comparatively large quantity of water for dissolving the polysaccharides, and extensive energy and time needed for drying with removal of the water. Furthermore, the geometry of the polymer product is difficult to define, owing to strong shrinkage effects which occur. A further disadvantage of the process is that usually it can be carried out only as a batch process. All in all, such a process is not suitable for the economic production of biopolymer.

Also known, furthermore, are other processes for producing biopolymers, examples being extrusion processes for enveloping a liquid, from WO 2018/172781 A1 and WO 2020/065270 A1, or a compression moulding process, from US 2017/0266847 A1. These processes, however, relate only to very narrow areas of application.

It is also known practice to use macroalgae and polysaccharides therefrom as fillers for polymers comprising, for example, polyethylene, in order to reduce the usage of petrochemical starting materials. With such materials, however, full biodegradability, which is a key advantage of biopolymers, is not attained.

### SUMMARY OF THE INVENTION

The invention includes a process for crosslinking polysaccharides from macroalgae to yield a polymer material in a processing chamber. The process includes the steps of producing a mixture comprising a solid containing polysaccharide from macroalgae and a water-containing liquid, with a ratio of liquid to solid of between 3:1 and 1:9, adjusting a pressure acting on the mixture to at least the vapour pressure of water at a first temperature, the first temperature being greater than/equal to 100° Celsius. and heating the mixture to the first temperature, wherein the solid comprises as polysaccharide at least one of alginate, alginic acid, agar and/or Carrageenan. The invention further includes a process for producing a biopolymer product from such a polymer material in an apparatus comprising a processing chamber and a shaping apparatus. The invention also includes a biopolymer product obtained by such a process.

The foregoing paragraph has been provided by way of introduction, and is not intended to limit the scope of the invention as described herein.

### BRIEF DESCRIPTION OF THE DRAWINGS

Below, the invention is elucidated in more detail with reference to the appended drawings, on the basis of preferred exemplary embodiments. The word “figure” is abbreviated to FIG. in the drawings.

In the drawings,

FIG. 1 shows a schematic process diagram of a process according to the first aspect of the invention;

FIG. 2 shows a schematic process diagram of a process according to the second aspect of the invention; and

FIG. 3 shows a schematic sectional view of an apparatus for performing a process according to the first and/or second aspect of the invention.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by this specification and the attached drawings and claims.

### DESCRIPTION OF THE PREFERRED EMBODIMENTS

For a general understanding of the present invention, reference is made to the drawings. The present invention will be described by way of example, and not limitation. Modifications, improvements and additions to the invention described herein may be determined after reading this specification and viewing the accompanying drawings; such modifications, improvements, and additions being considered included in the spirit and broad scope of the present invention and its various embodiments described or envisioned herein.

Proceeding from the current situation as described in the background of the invention section, it is an object of the present invention to improve the production of biopolymers, with elimination of at least one of the disadvantages stated in the background of the invention section. An object of the invention is achieved by the features of the independent main claims. Advantageous refinements are indicated in the dependent claims. Where technically possible, the teachings of the dependent claims may be combined as desired with the teachings of the main and dependent claims.

Below, advantages of the claimed aspects of the invention are explained, and, further below, preferred modified embodiments of the aspects of the invention are described. Explanations, particularly in relation to advantages and definitions of features, are fundamentally descriptive and preferred examples which, however, are not limiting. If an explanation is limiting, this is expressly stated.

Where elements are identified by means of numbering. i.e., for example, “first component”. “second component” and “third component”, this numbering is intended purely for differentiation in the designation and does not represent any dependency of the elements from one another or any mandatory sequence of the elements. This means in particular that an apparatus need not have a “first component” in order to be able to have a “second component”. The apparatus may also comprise a “first component”, and also a “third component”, though without necessarily having a “second component”. It is also possible for multiple units of one element of an individual numbering to be provided. i.e., for example, multiple “first components”.

According to a first aspect of the invention, the object is achieved by a process for crosslinking polysaccharides from macroalgae to give a polymer material in a processing chamber, comprising the steps as follows: producing a mixture comprising a solid containing polysaccharide from macroalgae and a water-containing liquid, with a ratio of liquid to solid of between 3:1 and 1:9, adjusting a pressure acting on the mixture to at least the vapour pressure of water at a first temperature, the first temperature being greater than/equal to 100° Celsius, and heating the mixture to the first temperature, wherein the solid comprises as polysaccharide at least one of alginate, alginic acid, agar and/or Carrageenan.

It is preferable for the sequence of process steps, unless technically necessary in an explicit sequence, to be able to be varied. Particularly preferred, however, is the aforesaid sequence of the process steps.

A polymer material is understood to be a material which is formed of crosslinked macromolecules, more particularly of crosslinked polysaccharides. A polymer product produced therefrom means that the polymer material is brought into a defined shape. In the case of a polymer product, in particular, desired physical properties are established additionally after shaping, more particularly through final drying and cooling of the polymer product. If the polymer material or the polymer product is given the prefix bio, it is a polymer material or polymer product, respective, that is produced from biodegradable substances, more particularly purely from biodegradable substances. A biopolymer material more particularly is formed purely of polysaccharides from macroalgae and in its entirety as well is fully biodegradable.

A processing chamber is, for example, a closed cavity in which first solid and liquid are introduced and thereafter the cavity is closed. There are then means present for heating and adjusting the pressure in the cavity. Preferably, however, the processing chamber is a processing chamber having an inlet and outlet, in which the process can be carried out continuously. The inlet and the outlet are then sealed, for example, by an inflowing mixture and an outflowing polymer material, respectively, allowing a pressure to prevail within the processing chamber. In the processing chamber, again, there are means provided for heating and adjusting the pressure.

A solid containing polysaccharide from macroalgae is formed more particularly by the macroalgae themselves, which with particular preference are dried and comminuted for the process. These macroalgae have a defined fraction of polysaccharides. The solid may also be formed by pure polysaccharides, in which case the polysaccharides for this purpose are extracted from the macroalgae, as a hydrocolloid, for example. Also possible is the use of an intermediate product between macroalgae and pure polysaccharides. The solid preferably has exactly one polysaccharide from alginate, alginic acid, agar or Carrageenan, or the solid used is alginate, alginic acid, agar or Carrageenan as a pure substance. Macroalgae used may be, for example, red algae such as Kappaphycus alvarezii or Euchema denticulatum or brown algae such as Saccharina latissima or Laminaria digitata.

The liquid is preferably formed substantially of water and may, moreover, also contain further substances, in relatively small fractions, for example. In particular, the liquid may also contain solids, which in that case are or become liquid at the first temperature and at the pressure prevailing in the processing chamber during the process. In the context of the definition of a mixing ratio between liquid and solid, such solids are counted as liquid. It is, moreover, also within the sense of the invention if constituents of the liquid or of the solid are added at different times during the running of the process. For example, the liquid may be supplied continuously during the heating. The ratio of liquid to solid always relates to the liquid supplied overall and to the solid supplied overall, and represents a ratio of the weight fractions (% by weight). In particular, the mixture may have been prepared from substances which in turn already contain a liquid fraction and a solid fraction. For example, added polysaccharides may have a moisture fraction, which in the mixture is then counted as the liquid. Also possible is the preparation of a premix which already contains a fraction of the liquid and a fraction of the solid and which in the processing chamber is mixed with further liquid or further solid.

The first aspect of the invention, then, embraces the teaching that the mixture is heated beyond 100° Celsius, i.e. the boiling point of water at standard pressure, with the pressure being increased in such a way that the water in the mixture remains liquid. In that case, therefore, the water or liquid is superheated. In this way, it is possible to achieve particularly high solubility of the polysaccharides in the liquid, allowing the liquid fraction in the mixture to be comparatively small. In this way, the process can be carried out with a small amount of liquid or of water, and in that sense is particularly sparing of resources. A temperature may be measured, for example, with a resistance temperature gauge having Pt100 sensors, and the present temperature figures may be subject to deviations within the bounds of the measurement accuracy of such Pt100 sensors.

Furthermore, the low liquid fraction in the mixture means that the polymer material after the crosslinking is already present with a low residual moisture content, of 10-20%, for example. The polymer material in that case already has dimensional stability such that it may be shaped to a biopolymer product without a further reduction in the residual moisture content, and the biopolymer product need subsequently be dried only a little or, with particular advantage, not at all, to a residual moisture content of 10%, for example. As a result of the first aspect of the invention, therefore, there is also no need for, or a reduction in, the expenditure of energy and time for the drying of the polymer material or biopolymer product. Moreover, after the shaping of the biopolymer product, the reduced drying requirement means that there is little or no shrinkage, and so the ultimate geometry of the polymer product is easy to define.

The polysaccharides used in the process according to the first aspect have particularly good solubility at the specified temperature of greater than/equal to 100° Celsius and result in a polymer material which has particularly good working properties, allowing the production therefrom of a biopolymer having advantageous properties. In one embodiment, the solid contains alginate, alginic acid, agar and Carrageenan; in an alternative embodiment, alginate, alginic acid and agar; in a further alternative embodiment, alginate, alginic acid and Carrageenan; in a further embodiment, alginate, agar and Carrageenan; and in yet a further alternative embodiment, alginic acid, agar and Carrageenan. In one embodiment, the solid contains alginate and alginic acid; in a further embodiment, alginate and agar, in a further embodiment, alginate and Carrageenan; in a further embodiment, alginic acid and agar; in a further embodiment, alginic acid and Carrageenan; and, in yet a further embodiment, agar and Carrageenan. In particularly preferred embodiments, the solid contains only alginate, only alginic acid, only agar or only Carrageenan.

The process according to the first aspect of the invention may readily be performed advantageously as a continuous process. In particular, the polymer material can be shaped as desired by means of various forming processes, providing access to a multiplicity of fields of application. All in all, a process is proposed by which biopolymer material or biopolymer products can be economically produced.

With the process, moreover, a pure biopolymer material is produced, with the biopolymer material or a biopolymer product comprising it being fully biodegradable.

In one embodiment of the process, the liquid contains exclusively water. The process created accordingly is particularly simple, and the polymer material or a polymer product produced from it has particularly good biodegradability.

In an alternative embodiment, the liquid comprises water and at least one adjuvant, the adjuvant being a solvent and/or a plasticizer. In this way, preferred physical properties of the polymer material and/or of a polymer product produced from it can be achieved. By means of an adjuvant acting as plasticizer, moreover, the drying effort for a polymer product produced from the polymer material is reduced. A solvent raises the solubility of the polysaccharides in the liquid, allowing a liquid fraction in the mixture to be further reduced, down to a ratio of liquid to solid of 1:9, for example. The advantages stated above for a low liquid content in the mixture then come about in a correspondingly reinforced way. In one refinement, at least one adjuvant is added to the mixture during or after the establishment of the pressure and the heating of the mixture.

An adjuvant in the form of a solvent preferably has a high polarity. In this way, good overall solubility of the polar polysaccharides can be achieved.

With further preference, the adjuvant is non-volatile. More particularly, an adjuvant in the form of a plasticizer is non-volatile. In that case, the adjuvant remains in a polymer product, and does not evaporate, during and after the drying and cooling of the polymer product. This is the case in particular when there are usage or transport conditions expected, more particularly an expected usage or transport temperature of the polymer product, at an ambient temperature, for example, of up to 80° Celsius. Such a temperature may prevail in a transport container, for instance, under solar irradiation.

The melting point of the adjuvant is preferably less than/equal to 100° Celsius. This ensures that under the processing conditions of the process according to the first aspect of the invention, the adjuvant is in liquid form.

In one preferred embodiment, the at least one adjuvant comprises glycerol and/or sorbitol. Glycerol and sorbitol each have particularly high polarity and accordingly are particularly suitable solvents. At the same time, glycerol and sorbitol are non-volatile and remain, after the drying and cooling, in a polymer product, where they act as plasticizers. While glycerol is already in liquid form beyond 18.2° C., the melting temperature of sorbitol is 95° Celsius. Sorbitol, therefore, is added as a solid to the mixture at ambient temperature, for example, and becomes liquid in the course of the process, when the melting temperature is reached. Sorbitol may also be added to the mixture after or during the beating of the mixture and in that case preferably already in liquid form, i.e. at a corresponding temperature of greater than/equal to 95° Celsius.

In further embodiments, at least one adjuvant is formed by pentaerythritol, polyol, sugar alcohol, poly(oxyethylene), poly(oxypropylene), nonionic surfactants and/or anionic surfactants, which in each case act in particular as plasticizers in a polymer product. Further preferred adjuvants which act in particular as solvents in the mixture are glycols, examples being ethylene glycol or diethylene glycol, methanol, ethanol, maltodextrin and/or urea.

The following, additionally, may be present as adjuvant in the liquid or as adjuvant in the solid: 1,3-butylene glycol, acetic esters and fatty acid esters of glycerol, acetone, acetylated distarch adipate, acetylated monoglycerides, acid-treated starch, alkali-treated starch, ascorbic acid, ascorbyl palmitate, ascorbyl stearate, azodicarboxamide, beeswax, bleached starch, bone phosphate, brominated vegetable oil, calcium acetate, calcium aluminium silicate, vegetable oils, calcium ascorbate, calcium benzoate, calcium bromate, calcium carbonates, calcium chloride, calcium citrate, calcium dihydrogenphosphate, calcium ferrocyanide, calcium gluconate, calcium hydrogensulfite, calcium hydroxide, calcium iodate, calcium lactate, calcium lactate gluconate, calcium lactobionate, sucrose, calcium peroxide, calcium phosphate, calcium polyphosphates, calcium salts of fatty acids, calcium silicate, calcium sorbate, calcium stearate, calcium stearoyllactylate, calcium sulfate, calcium tartrate, soya protein, calcium iodate, candelilla wax, carnauba wax, carob gum, castor oil, citric acid, pea protein, citric esters and fatty acid esters of glycerol, crosslinked sodium carboxymethylcellulose, carboxymethylcellulose, copper sulfate of mono- and diglycerides of fatty acids, diammonium hydrogen phosphate, dicalcium pyrophosphate, diethyl pyrocarbonate, ethyl alcohol, ethylcellulose, ethylhydroxyethylcellulose, esters of glycerol and thermally oxidized soya fatty acids, zein, ethoxylated mono- and diglycerides, ethylhydroxyethylcellulose, formic acid, gelatine, glycerol, guar gum, gum arabic, peroxide derivatives, hydrogen peroxide, hydroxylated lecithin, hydroxypropylcellulose, hydroxypropyl distarch, cellulose derivatives.

In one preferred embodiment, the first temperature is between 100° and 180° Celsius. With particular preference, the first temperature is between 100° and 150° C. In these temperature ranges, it is possible to achieve an advantageous ratio between good solubility of the polysaccharides in the liquid and the energy expenditure needed to heat the mixture and to raise the pressure to or above the vapour pressure of water.

A second aspect of the invention relates to a process for producing a biopolymer product in an apparatus having a processing chamber and a shaping apparatus, comprising the steps of: crosslinking polysaccharides from macroalgae to form a polymer material in the processing chamber by a process according to the first aspect of the invention, shaping the polymer material in the shaping apparatus to form a biopolymer product, optionally drying the biopolymer product, and cooling the biopolymer product. The drying of the biopolymer product here is optional in so far as it is or must be carried out only when a corresponding residual moisture content is present in the biopolymer product after shaping—when, that is, the residual moisture content is higher than is desired.

The process according to the second aspect of the invention therefore encompasses the process according to the first aspect of the invention, and has the advantages thereof correspondingly. In particular, with low energy, water and time expenditure, a fully biodegradable polymer product is generated, which, moreover, has an easily definable geometry.

The processing chamber may be formed, for example, by a simple cavity in which the process is carried out batchwise. In one preferred embodiment, the processing chamber is formed by a screw extruder. With particular preference, the screw extruder is formed as a twin-screw extruder. In the case of a screw extruder, one or more parallel screws extend through a channel and on the inlet side draw in the liquid and the solid, or the mixture thereof, and on the outlet side press the completed polymer material into or through a shaping apparatus. With preference there is thorough mixing of solid and liquid in the screw extruder. Through the geometry of the screw or screws and through the operating parameters of the screw extruder here, it is possible to define the feed performance of the screw extruder and also the pressure acting on the mixture. This pressure is preferably able to escape from the processing chamber neither on the inlet side nor on the outlet side, since inlet and outlet are sealed off by the mixture and by the polymer material, respectively. For example, on the inlet side in the processing chamber there is sealing through the conveying of new solid and liquid into the processing chamber. On the outlet side, the shaping apparatus then generates a pressure drop, so that the established pressure acts on the mixture in the processing chamber and at the discharge point the pressure equalizes to the ambient pressure.

With particular preference, the shaping apparatus is formed by an extrusion die. With a die of this kind, a polymer material emerging from a processing chamber for continuous mixing, more particularly from a screw extruder, can be shaped continuously into an infinite shape, for example to form a film, a film intermediate or a profile. Drying subsequent to the shaping, and cooling, may then take place, for example, under ambient conditions, it being possible to utilize the residual heat of the biopolymer product for the purpose of drying the biopolymer product.

In a further embodiment, the shaping apparatus is formed by an injection moulding apparatus. In that case, comparatively complex geometries can be produced with the polymer material by means of injection moulding.

A third aspect of the invention relates to a biopolymer product obtained by a process according to the second aspect of the invention. The biopolymer product has the advantages of the first and second aspects of the invention correspondingly. In particular, the biopolymer product is fully biodegradable and can have comparatively complex and precisely defined geometries.

The exemplary embodiments described are merely examples, which within the ambit of the claims may be modified and/or supplemented in diverse ways. Each feature described for a particular exemplary embodiment may be utilized on its own or in combination with other features in any other exemplary embodiment. Each feature which is described for an exemplary embodiment in a defined claim category may also be employed correspondingly in an exemplary embodiment of a different claim category.

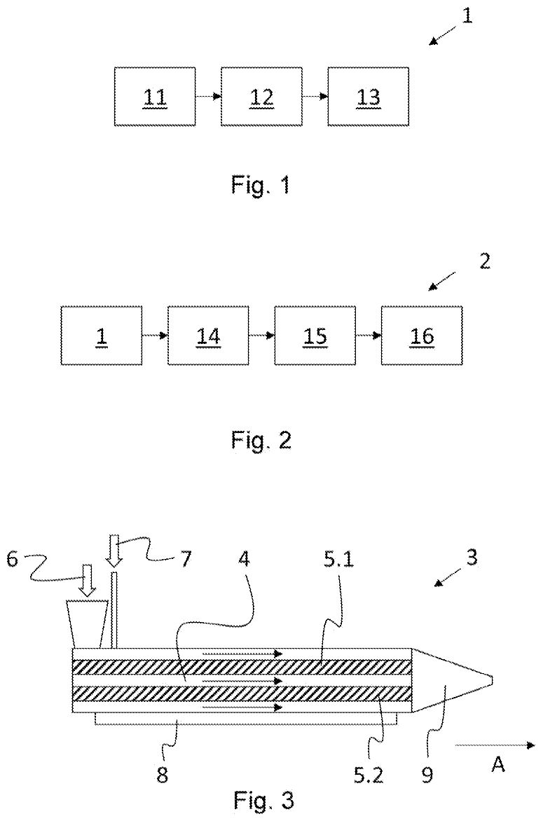

FIG. 1 shows a process 1 according to the first aspect of the invention for crosslinking polysaccharides from macroalgae to form a polymer material in a processing chamber. In a first step 11, a mixture of a solid comprising polysaccharide from macroalgae and a water-containing liquid is produced, with a ratio of liquid to solid of between 3:1 and 1:9. The solid here is preferably formed of the macroalgae themselves, from pure polysaccharides which have been obtained from macroalgae, or from an intermediate product. The solid contains, as polysaccharides, alginate, alginic acid, agar and/or Carrageenan. The solid preferably contains no polysaccharides other than those stated, and more preferably contains exactly one of the stated polysaccharides. In a second step 12, a pressure acting on the mixture is adjusted to at least the vapour pressure of water at a first temperature, the first temperature being greater than/equal to 100° Celsius. In a third step 13, the mixture is heated to the first temperature. The second step 12 and the third step 13 may be performed successively or else simultaneously.

FIG. 2 shows a process 2 according to the second aspect of the invention for producing a biopolymer product in an apparatus having a processing chamber and a shaping apparatus. The process 2 comprises first of all the process 1, in which a polymer material is produced via crosslinking of polysaccharides from macroalgae in the processing chamber. This is followed in a fourth step 14 by shaping of the polymer material in the shaping apparatus to form a biopolymer product. The shaping apparatus may be, for example, an extrusion die or an injection moulding apparatus. In an optional fifth step 15, the biopolymer product undergoes drying, while in a sixth step 16 the biopolymer product undergoes cooling. The fifth step 15 and the sixth step 16 may take place simultaneously, and the residual heat taken off as a result of the cooling is also utilized for drying the biopolymer product.

FIG. 3 shows an apparatus 3 for performing a process 1 according to the first aspect of the invention and/or a process 2 according to the second aspect of the invention. The apparatus 3 is configured as a twin screw extruder and has a processing chamber 4, in which two screws 5.1, 5.2 are disposed on parallel axes of rotation. The screws 5.1, 5.2 are represented in a highly simplified way, but have turns, not represented, which have geometries matched to one another, meaning that the screws 5.1, 5.2 on rotation exert a pressure on a medium located in the processing chamber 4, and also produce mixing of the medium and also conveying of the medium in an axial direction A.

Introduced into the processing chamber 4 is solid 6, containing polysaccharides from macroalgae, via a hopper, and liquid 7, containing water and optionally at least one adjuvant, via a hose. The solid 6 and the liquid 7 are mixed in the processing chamber 4 by means of the screws 5.1, 5.2. The resulting mixture is conveyed along the processing chamber 4 in the axial direction A, during which it is further mixed and pressurized. Furthermore, the mixture is heated via heating means 8 to a temperature greater than/equal to 100° C. Furthermore, an input of thermal energy also takes place by way of the mechanical work which the screws 5.1, 5.2 perform on the mixture. In this way, during passage through the processing chamber 4, the polysaccharides in the mixture are crosslinked to form a polymer material.

At an outlet from the processing chamber 4, located at the end in the axial direction A, there is a shaping apparatus 9 disposed, through which the polymer material is pressed. The shaping apparatus 9 is configured, for example, as an extrusion die, with the extrusion die executing a shape-imparting extrusion to give a desired geometry—for example, the geometry of a profile, of a film or of a film intermediate. Following the extrusion die, for example, is a cooling and drying section, which is not shown in detail but via which a biopolymer product shaped at the extrusion die can be cooled and/or dried. The shaping apparatus 9 may also be configured as an injection nozzle for injecting the polymer material into an injection mould. A biopolymer product shaped by injection moulding is then demoulded from the injection mould after the shaping operation, for example, and is cooled and/or dried in the ambient air.

### LIST OF REFERENCE SYMBOLS

1 process
2 process
3 apparatus
4 processing chamber
5.1 screw
5.2 screw
6 solid
7 liquid
8 heating means
9 shaping apparatus
11 first process step—producing a mixture
12 second process step—adjusting a pressure acting on the mixture
13 third process step—heating the mixture
14 fourth process step—shaping the polymer material
15 fifth process step—drying the biopolymer product
16 sixth process step—cooling the biopolymer product
A axial direction

While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of this specification and the attached drawings and claims.

What is claimed is:

1. A process (1) for crosslinking polysaccharides from macroalgae to yield a polymer material in a processing chamber (4), the process comprising the steps (11, 12, 13) of:
producing a mixture (11) comprising a solid (6) containing polysaccharide from macroalgae and a water-containing liquid (7), with a ratio of liquid (7) to solid (6) of between 3:1 and 1:9;
adjusting a pressure (12) acting on the mixture to at least the vapour pressure of water at a first temperature, the first temperature being greater than/equal to 100° Celsius; and
heating the mixture (13) to the first temperature;
wherein the solid (6) comprises as polysaccharide at least one of alginate, alginic acid, agar and/or Carrageenan.

2. The process (1) according to claim 1, wherein the liquid (7) contains exclusively water.

3. The process (1) according to claim 1, wherein the liquid (7) contains water and at least one adjuvant, the adjuvant being a solvent and/or a plasticizer.

4. The process (1) according to claim 3, wherein an adjuvant embodied as a solvent has a high polarity.

5. The process (1) according to claim 3, wherein the adjuvant is non-volatile.

6. The process (1) according to claim 3, wherein the melting point of the adjuvant is less than/equal to 100° Celsius.

7. The process (1) according to claim 3, wherein the at least one adjuvant comprises glycerol and/or sorbitol.

8. The process (1) according to claim 1, wherein the first temperature is between 100° and 180° Celsius, preferably between 100° and 150° C.

9. A process (2) for producing a biopolymer product in an apparatus (3) having a processing chamber (4) and a shaping apparatus (9), the process comprising the steps (11, 12, 13, 14, 15, 16) of:
crosslinking polysaccharides from macroalgae to form a polymer material in the processing chamber (4)(11, 12, 13) by the process (1) of claim 1;
shaping the polymer material (14) in the shaping apparatus (9) to form a biopolymer product;
optionally drying the biopolymer product (15); and
cooling the biopolymer product (16).

10. The process (2) according to claim 9, wherein the processing chamber (4) is formed by a screw extruder, more particularly a twin-screw extruder.

11. The process (2) according to claim 9, wherein the shaping apparatus (9) is formed by an extrusion die.

12. The process (2) according to claim 9, wherein the process (2) is performed continuously.

13. The process (2) according to claim 9, wherein the biopolymer product is shaped as a film, a film intermediate or a profile.

14. The process (2) according to claim 9, wherein the shaping apparatus (9) is formed by an injection moulding apparatus.

15. A biopolymer product obtained by a process (2) according to claim 9.
